(19) United States
(12) Patent Application Publication
(10) Pub. No.: US 2010/0129772 A1
(43) Pub. Date: May 27, 2010

(54) Captive thread dental implant apparatus

(76) Inventors: David Sklarski, Portsmouth, RI (US); John Souza, Attleboro, MA (US)

Correspondence Address: PATTON BOGGS LLP, 2550 M STREET NW, WASHINGTON, DC, 20037-1350, US

(21) Appl. No.: 12/292,590

(22) Filed: Nov. 21, 2008

(51) Int. Cl. A61C 8/00

(52) U.S. Cl. 433/173

(57) ABSTRACT

A captive thread dental implant apparatus including a removable support member having a first receptacle on one end and a first threaded shank portion on the other end, the removable support member having a non-threaded shank portion extending between the first threaded shank portion and the first receptacle; and an anchor implant member having a lower body portion on one end and a second receptacle on the other end for receiving the first threaded shank portion of the removable support member, the second receptacle having a second threaded portion located within the second receptacle for engaging the first threaded shank portion, the non-threaded shank portion located adjacent to the second threaded shank portion when the removable support member is joined with the anchor implant member.

### FIELD OF THE INVENTION

The present invention relates to a dental implant apparatuses, and more specifically relates to captive thread dental implant apparatuses.

### DESCRIPTION OF BACKGROUND INFORMATION

Without limiting the scope of the present invention, its background will be described in relation to a captive thread dental anchor apparatus as an example.

Various methods and structures for anchoring appliances in the oral cavity are known in the art. For example, U.S. Pat. No. 4,540,367 issued to Sulc (“the '367 patent”) describes a multi-piece apparatus having a female member which attaches to a surface of a tooth adjacent to an apparatus anchoring site. Also shown in the '367 patent is an oral appliance containing a male member which attaches to the female member. The apparatus and method described by the '367 patent, although particularly useful for attaching to a dental surface adjacent to a desired anchoring site, is not optimal for all anchoring requirements.

Another anchoring method and apparatus is described by U.S. Pat. No. 5,749,732 issued to Sendax (“the '732 patent”). The apparatus described by the '732 patent comprises a threaded anchor post having a square male upper extension using a wrench having a square socket, the threaded portion is rotated to attain threaded engagement with a bone. After the threaded portion has penetrated the bone to a suitable depth, the square male upper extension remains above the gum. The threaded post portion has a lower threaded portion and an upper threaded portion separated by an unthreaded land. The '732 patent describes the unthreaded land as functioning to assist bone growth engagement thereby securing the anchor from unthreading. The square upper extension mates with and is secured by adhesive to an oral appliance having a corresponding square receptacle. Additionally, there are commercially available anchors similar to the device described in the '732 patent but without the unthreaded land.

The apparatus and method described by the '732 patent and the similarly structured commercial products have shortcomings. One is that the upper extension in its cooperative fit with a dental appliance offers little, if any, adjustment after insertion. More particularly, the orientation of the upper extension is fixed by the rotational angle and insertion angle at the threaded portion. The orientation of this receptacle in the dental appliance which is shaped to correspond to the upper extension is also fixed relative to the appliance. However, after the threaded portion is screwed into the recipient's bone, changing its angle requires removal and reinsertion. After a period of time, bone growth fixes the rotational position as well. Therefore, after insertion of the threaded anchor, the angle and position of the dental appliance is substantially fixed.

Various methods and apparatie for adjusting the angle of a dental appliance anchor are also know. For example U.S. Pat. No. 4,713,004 issued to Linkow, et al. (“the '004 patent”) discloses an implant placed in the bone and rotated into a proper orientation. The '004 patent shows a wedge shaped collar having an angle upper surface which is described as positioned to coincide with the angle of the shaft so that the free end of the shaft extends perpendicularly from the angled surface. The '004 patent further shows a prosthetic tooth anchor threaded onto the free end of the shaft to secure the collar in a fixed orientation. The '004 patent apparatus and method, although directed to an alignment issue, is relatively complex and may have insufficient structural rigidity for some applications.

In another example, U.S. Pat. No. 5,195,891 also issued to Sulc (“the '891 patent”) discloses a three piece adjustable dental implant system. The three piece dental implant system includes an implant that is inserted into the bone of a patient and has a threaded cavity which accepts a threaded shaft base. Once the threaded shaft base is threaded into the threaded cavity of the implant, no further rotation of the base is allowed. The upper part of the base includes a cavity which has an interference fit with and angled support thereby providing a three piece adjustable dental implant system.

In yet another example, U.S. Pat. No. 6,695,616 issued to Ellison (“the '616 patent”) discloses a two piece apparatus and method for anchoring a dental appliance. This two piece dental appliance includes an upper removal support anchor which snaps into by an interference fit into an anchor implant member which is screwed into the bone of a patient. The upper removal support member may be an angled member such that it accepts a dental prosthesis and fits a desired angle. The anchored implant member includes an upper receptacle and an undercut which receives the upper removable support member and where adhesives may be applied such that the interference fit allows rotation of the upper removal support member prior to setting of the adhesive.

### SUMMARY OF THE INVENTION

The above described problems are solved and technical advances achieved by the present dental anchor apparatus. In one embodiment the present captive thread dental implant apparatus includes a removable support member having a first receptacle on one end and a first threaded shank portion on the other end, the removable support member having a non-threaded shank portion extending between the first threaded shank portion and the first receptacle; and an anchor implant member having a lower body portion on one end and a second receptacle on the other end for receiving the first threaded shank portion of the removable support member, the second receptacle having a second threaded portion located within the second receptacle for engaging the first threaded shank portion, the non-threaded shank portion located adjacent to the second threaded shank portion when the removable support member is joined with the anchor implant member. In one aspect the non-threaded shank portion has a diameter that is less than the diameter of second threaded portion. In another aspect, the second threaded shank portion is disengaged and in a longitudinally captive thread arrangement from the first threaded shank portion when the removable support member is joined with the anchor implant member.

In yet another aspect, the removable support member is freely rotatable relative to the anchor implant member when the removable support member is joined with the anchor implant member. Preferably, the removable support member further includes an abutment portion located between the first receptacle and the first threaded portion and extending laterally from the removable support member for abutting against the second receptacle to provide a stop between removable support member and the second receptacle. Additionally, the abutment portion may have a diameter that is one of greater or equal to the outer diameter of the second receptacle. Further, the lower body portion may include a longitudinally extending threaded portion for engaging the bone of a patient for anchoring the anchor implant member to a bone of a patient.

In another embodiment, the present captive thread dental implant apparatus includes a removable support member having a first receptacle on one end and a first threaded shank portion on the other end, the removable support member having a non-threaded shank portion extending between the first threaded shank portion and the first receptacle, wherein the first receptacle provides a female interference fit for releasably engaging a male end of a dental prosthesis; and an anchor implant member having a lower body portion on one end and a second receptacle on the other end for receiving the first threaded shank portion of the removable support member, the second receptacle having a second threaded portion located within the second receptacle for engaging the first threaded shank portion, the non-threaded shank portion located adjacent to the second threaded shank portion when the removable support member is joined with the anchor implant member.

In one aspect, the non-threaded shank portion may have a diameter that is less than the diameter of second threaded portion. In another aspect, the second threaded shank portion may be disengaged and in a longitudinally captive thread arrangement from the first threaded shank portion when the removable support member is joined with the anchor implant member. Preferably, the female interference fit may include a divergent-convergent-divergent cross-sectional diameter. Additionally, the removable support member may include an abutment portion located between the first receptacle and the first threaded portion and extending laterally from the removable support member for abutting against the second receptacle to provide a stop between removable support member and the second receptacle. Also, the abutment portion may have a diameter that is one of greater or equal to the outer diameter of the second receptacle.

In another aspect, the lower body portion may further include a longitudinally extending threaded portion for engaging the bone of a patient for anchoring the anchor implant member to a bone of a patient. In yet another aspect, the first receptacle may further include at least one aperture disposed through the first receptacle. Additionally, the removable support member may include a cavity extending longitudinally from the first threaded shank portion towards the first receptacle.

In yet another embodiment, the present captive thread dental implant apparatus may include a removable support member having a first receptacle on one end and a first threaded shank portion on the other end, the removable support member having a non-threaded shank portion extending between the first threaded shank portion and the first receptacle, wherein the first receptacle is adapted to releasably engage a male end of a dental prosthesis; and an anchor implant member having a lower body portion on one end and a second receptacle on the other end for receiving the first threaded shank portion of the removable support member, the second receptacle having a second threaded portion located within the second receptacle for engaging the first threaded shank portion, the non-threaded shank portion located adjacent to the second threaded shank portion when the removable support member is joined with the anchor implant member.

In one aspect, the non-threaded shank portion may have a diameter that is less than the diameter of second threaded portion. In another aspect, the lower body portion may further include a longitudinally extending threaded portion for engaging the bone of a patient for anchoring the anchor implant member to the bone of the patient. Preferably, the second threaded shank portion may be disengaged and in a longitudinally captive thread arrangement from the first threaded shank portion when the removable support member is joined with the anchor implant member, wherein the removable support member is freely rotatable relative to the anchor implant member when the removable support member is joined with the anchor implant member.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 illustrates a perspective exploded view of a dental anchor apparatus according to an embodiment of the present invention;

FIG. 2 illustrates a perspective view of a joined dental anchor apparatus of FIG. 1 according to an embodiment of the present invention;

FIG. 3 illustrates another exploded perspective view of the dental anchor apparatus of FIG. 1 according to an embodiment of the present invention;

FIG. 4 illustrates a exploded cross-section view of the dental anchor apparatus of FIG. 1 according to an embodiment of the present invention; and

FIG. 5 illustrates a cross-section view of the joined dental anchor apparatus of FIG. 1 according to an embodiment of the present invention.

### DETAILED DESCRIPTION OF THE DRAWINGS

While the making and using of various embodiments of the present invention are discussed in detail below, it should be appreciated that the present invention provides many applicable event of concepts which can be embodied in a wide variety of specific context. The specific embodiments discussed herein are merely illustrated of specific ways to make and use the invention and do not delimit the scope of the present invention.

In the following description of the representative embodiments of the invention, directional terms such as “above,” “below,” “upper,” “lower,” etc. are used for convenience in referring to the accompanying drawings. In general, “above,” “upper,” and “upward” and similar terms refer to a direction with respect to the dental anchor apparatus orientated in a generally upward fashion such that a dental prosthesis would snap onto the top of the dental anchor apparatus. Additionally, terms such as “below,” “lower,” and “downward” and similar terms refer to a direction away or opposite of the upward direction. In another embodiment these relative terms may be reversed such that the dental anchor implant apparatus may be in the opposite direction as discussed. For example, if the dental anchor apparatus were to be used in a top row or teeth of a recipient or patient, then the relative direction terms would be the opposite than those used for the dental anchor apparatus being used on the bottom row of teeth of the recipient or patient.

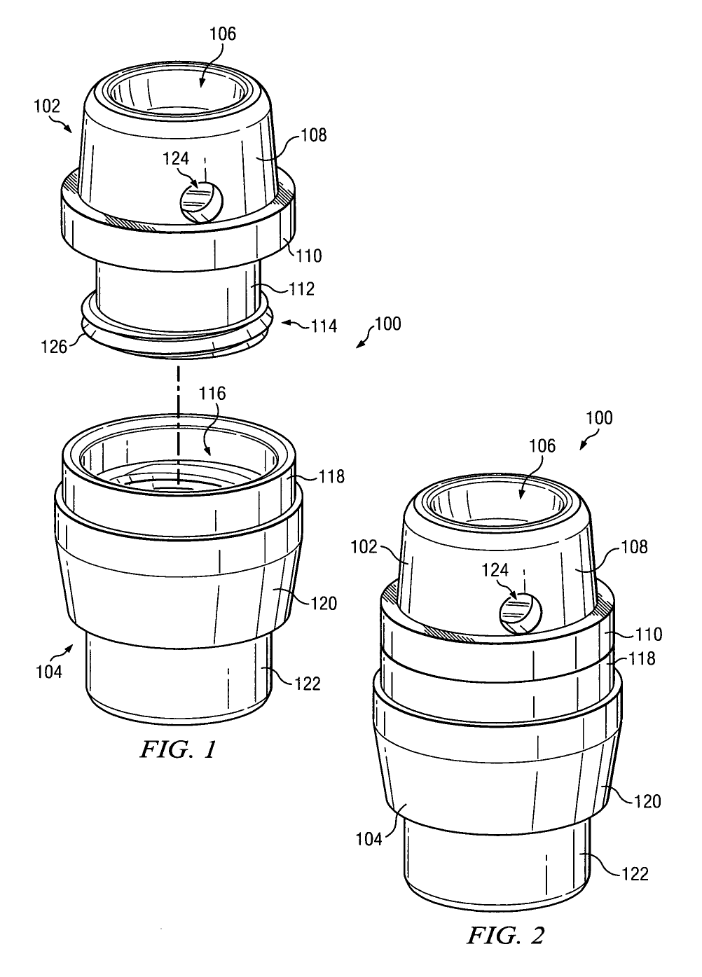

Referring initially to FIGS. 1-3, an embodiment of a captive thread dental anchor apparatus (“dental anchor apparatus”) is illustrated and generally designated 100. Dental anchor apparatus 100 may include a removable support member 102 and an anchor implant member 104. These members may be joined as shown in the figures. Removable support member 102 may include an upper body portion 108, which may define or form a receptacle 106 for receiving a dental prosthesis, as further described herein.

Removable support member 102 may further include an abutment portion 110, which has a greater diameter then the upper body portion 108, in one example. In this manner upper body portion 108 extends down to abutment portion 110 of removable support member 102. Extending from abutment portion 110 downward is a non-threaded shank portion 112, which generally has a diameter less than abutment portion 110. In one example, abutment portion 110 and non-threaded shank portion 112 are also generally cylindrical in shape or form. In one aspect, the non-threaded shank portion 112 extends down and terminates in threaded shank portion 114 which contains one or more or plurality of threads 126 as is commonly known in the art.

Anchor implant member 104 may also be substantially cylindrically shaped member that includes a receptacle 116 for receiving threads 126, threaded shank portion 114, and non-threaded shank portion 112. In one aspect, receptacle 116 may be formed or shaped by a receptacle base portion 118, which further is substantially cylindrically shaped or formed. As shown in FIG. 2, abutment portion 110 abuts against receptacle base portion 118 when upper body portion 108 is inserted into and joined with anchor implant member 104.

Extending from receptacle base portion 118 downward is upper body portion 120 of anchor implant member 104. As shown, upper body portion 120 may have a tapering shape or form as it transitions from receptacle base portion 118 to a lower body portion 122. Lower body portion 122 is shown without threads or threaded portion in one embodiment. In another embodiment, lower body portion 122 may be a threaded portion as depicted by U.S. Pat. No. 6,695,616 issued to Ellison, which is hereby incorporated by reference. In this embodiment, lower body portion 122 includes a threaded portion for threading into the bone of a recipient or patient.

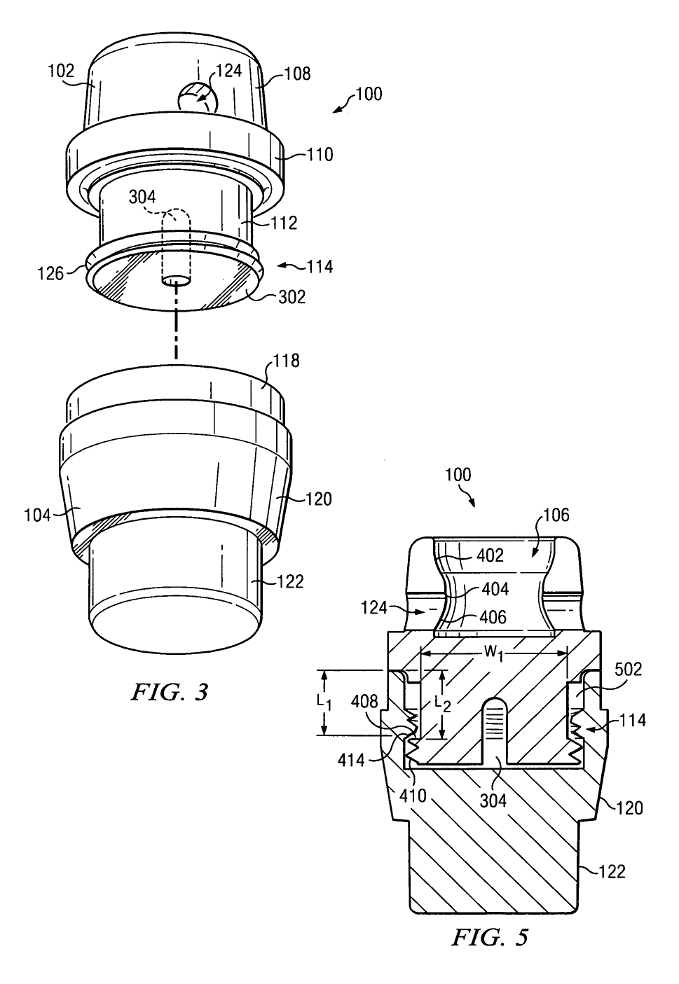

Referring now to FIG. 3, removable support member 102 can be seen with a cavity 304 extending from a bottom surface 302 of removable support member 102 upward through the interior portion of removable support member 102. Generally, cavity 304 extends inward through removable support member 102 substantially along it longitudinal axis, for example. Cavity 304 may extend inward from bottom surface 302 to any desired depth within the longitudinal axis generally of the removal support member 102, for example.

Although removable support member 102 is generally shown as a straight or linear cylindrical or substantially cylindrical shaped object, removable support member 102 may further include an angled support member or be an angled shaped former object as disclosed in U.S. Pat. No. 6,695,616 issued to Ellison, which is hereby incorporated by reference. In one embodiment, removable support member 102 may have an upper body portion 108, which has a longitudinal axis that is angled from the longitudinal axis of abutment portion 110, nonthreaded shank portion 112, and threaded shank portion 114. This is so to accept a dental prosthesis that provides a different angle within the oral cavity of a patient. Thus, although a substantially linear removable support member 102 is shown, dental anchor apparatus 100 further includes embodiments where the removable member 102 has an angled upper body portion 108 relative to the lower portion of removable support member 102.

Removable support member 102 and anchor implant member 104 may be a metal structure and formed of a titanium-aluminum-vanadium alloy or any other metal, composition, or alloy as desired. In another embodiment, removable support member 102 may be made from a different metal, composition, or alloy of materials than anchor implant member 104. Additionally, the general lateral cross-section shape of removable support member 102 and anchor implant member 104 may be other than substantially cylindrical, such as a polygonal shape, such as hexagonal and pentagonal, for example. Additionally, anchor implant member 104 may have flat surfaces on the upper body portion 120 for accepting a wrench or other tool for inserting the anchor implant member 104 into the bone of a recipient or patient and applying torque, such that the anchor implant member 104 is located substantially below the gum line of a jaw bone (not shown) with the lower body portion 122 threaded into or inserted into the underlying bone of the patient.

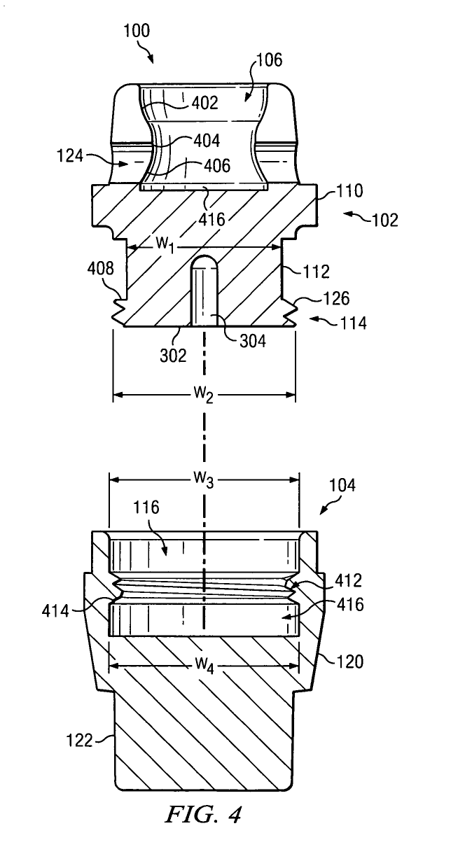

Referring now to FIGS. 4 and 5, an exploded and non-exploded view of dental anchor apparatus 100 is shown. These cross-section views show abutment portion 110 having a wider diameter than the non-threaded shank portion 112, such that the non-threaded shank portion 112 extends a distance between abutment portion 110 and threads 126 of threaded shank portion 114. The width (w₁) of the diameter of non-threaded shank portion 112 has a smaller diameter than the threaded shank portion 114 which is shown having a diameter of (w₂), for example.

Anchor implant member 104 is shown having receptacle 116 with a general diameter of the opening of receptacle 116 being shown as (w₃). The diameter (w₃) of receptacle 116 is greater than the diameter of the threaded portion 412 of anchor implant member 104, threaded portion 412 located substantially within receptacle 116 of anchor implant member 104. Likewise, a lower portion of the receptacle 116 noted as lower portion 416 has a greater diameter (w₄) than threaded portion 412 of anchor implant member 104. In one embodiment, as removable support member 102 is joined or inserted into anchor implant member 104, the threads 126 of removable support member 102 slide down within and through diameter (w₃) of receptacle 116. As threads 126 slide down into receptacle 116, they stop and engage threaded portion 412 of receptacle 116. At this point, removable support member 102 may be rotated such that threads 126 engage threaded portion 412 of receptacle 116.

As removable support member 102 is rotated further, threads 126 engage further threaded portion 412 until they clear or fully disposed all the way through threaded portion 412 and are located in lower portion 416 of anchor implant member 104, as best illustrated as in FIG. 5. Continuing now with FIG. 5, removable support member 102 can be seen fully joined with anchor implant member 104; threads 126 having a diameter (w₂) are substantially wider than the threaded shank portion 114 of removable support member 102. In this way, removable support member 102 is free to continue to rotate within the receptacle 116 of anchor implant member 104 while being retained by the threaded shank portion 114 of lower portion 416 and threaded portion 412 of anchor implant member 104. Referring back to FIG. 4, receptacle 116 may further include a tapered portion 414 that transitions from threaded portion 412 to lower portion 416 of anchor implant member 104. The tapered portion 414 may have a gradient radial diameter transitioning from threaded portion 412 to lower portion 416, for example. In one embodiment, the tapered portion 414 further retains threads 126 of removable support member 102 such that the removable support member 102 is captive to anchor implant member 104 and may be rotated freely for further alignment of removable support member 102 within the oral cavity of a patient while being retained or joined longitudinally.

As shown, non-threaded shank portion 112 has a length noted as “L₂” that may be slightly longer than the length “L₁” of the receptacle base portion 118 and upper body portion 120 such that the non-threaded shank portion 112 is adjacent to and rotates against the threaded portion 412 of anchor implant member 104, for example. Additionally, a space 502 may be provided between the removable support member 102 and the anchor implant member 104 and also further between non-threaded shank portion 112 and threaded portion 412 of anchor implant member 104. Further, some space or available volume within the receptacle 116 may be provided near or at the bottom surface 302 and the interior bottom of receptacle 116 of implant anchor member 104 for holding an adhesive. By the engagement of threads 126 of removable support member 102 against tapered portion 414 of anchor implant member 104, it can be seen that removable support member 102 is held captive and may be freely rotated within the receptacle 116 for further positioning and alignment as desired. This captive thread arrangement allows a medical professional to rotate removable support member 102 relative to anchor implant member 104 such as to find a desirable position among the teeth in the oral cavity of a patient prior to joining removable support member 102 with anchor implant member 104 with an adhesive, for example. In this regard, a dental prosthesis may be then inserted into receptacle 106 of removable support member 102 for further alignment and positioning as desired prior to joining the members with an adhesive.

By removable support member 102 being freely rotatable relative to anchor implant member 104, different removable support members 102 may be tried and quickly inserted and removed from anchor implant member 104 until the desired size and shape and angle of removable support member 102 can be found. Additionally, the captive thread arrangement between a removable support member 102 and anchor implant member 104 provides for a secured longitudinal restrained relationship between these two members, thus providing further longitudinal rigidity to removable support member 102 relative to anchor implant member 104 during fitting and adhesion of a dental prosthesis. In one embodiment, once the desired removable support member 102 is located and positioned, it may be removed from anchor implant member 104 such that adhesive may be placed within the receptacle 116 of anchor implant member 104. Then, later inserting removable support member 102 back into receptacle 116 it can be rotated in the captive thread arrangement as described herein, and later set with adhesive that is placed within the receptacle 116 as would be known by those commonly skilled in the art.

It will be understood that the example receptacle 116 described above is for purposes of explaining the operation of and providing general guidance in the practicing of this invention. Upon reading this disclosure, other structures for the receptacle 116 to provide for rotation of the removable support member 102 prior to setting of its adhesive, can be readily identified by persons skilled in the art.

As described in the '181 and '367 patents, the male extension within a dental prosthesis (not shown) is preferable formed of a plastic material or other type of material having sufficient strength and durability to permit repeated connection and disconnection with the receptacle 106 of removable support member 102. In addition, the material of the male extension should develop a retaining friction between it and the material of the receptacle 106 to maintain attachment of the male extension and, accordingly, the attachment of the dental prosthesis. Further, the material of the male extension should permit removal and reinsertion of the male cap when desired. This is preferred because the male extension typically absorbs wear during time and chewing forces, and as a result, should be periodically, or may be periodically replaced. An example material for the male extension may be strong nylon, for example. An example replacement technique by which one male cap is removed and replaced by another is described in the Sulc '367 patent.

An example method for installing an anchor implant member 104 and removable support member 102 of this invention will be described. First, the installation site, such as a jaw bone, is prepared using established methods within the dental and oral surgery arts. Next, the bone is predrilled using a drill bit diameter and drilling depth selected by one skilled in the relevant arts. The tapered end of the lower body portion 122 of the anchor implant member 104 is then placed into the drilled area, and using a wrench or other tool, is screwed into the bone until the surface of the lower body portion 122 is at the desired height.

Next, using an alignment handle such as described in the '181 patent, or by direct visual inspection, an appropriate angle, whether it be linear or angular of the removable support member 102, is chosen. Typically, these angles may be zero, five, eleven and seventeen degrees, for example. Therefore, in a typical method according to this invention, the dentist or oral surgeon would have an assortment of angled and linear removable support members 102, for example.

The removable support member 102 is inserted into the receptacle 116 such that threads 126 and threaded shank portion 114 are inserted into the receptacle base portion 118 of anchor implant member 104. As the threads engage the threaded portion 412 of anchor implant member 104, the removable support member 102 is rotated by the dentist or oral surgeon such that the threads 126 engage the threaded portion 412 of anchor implant member 104.

Upon the engagement of threads 126, with the threaded portion 412 of anchor implant member 104, the removable support member 102 is inserted and screwed into the anchor implant member 104 until the threads 126 of the threaded shank portion 114 pass all the way through threaded portion 412 of anchor implant member 104. Upon the threads 126 clearing the threaded portion 412 of anchor implant member 104, threads 126 are then captive within the lower portion 416 of anchor implant member 104, for example.

At this point, removable support member 102 is captive within anchor implant member 104 such that it may be rotated to a desirable rotation where the angle or linear part of the receptacle 106 is aligned with the adjacent teeth. A dental prosthesis may then be placed within receptacle 106 so that the dentist and oral surgeon can determine whether the dental prosthesis is correctly aligned relative to its adjacent teeth within the oral cavity of a recipient or patient. Once it is found that the removable support member 102 is the proper and desired removable support member 102 having a desired angular or linear longitudinal axis, it is then removed, or may be removed from anchor implant member 104 by rotating in an opposite direction such that the threads 126 re-engage threaded portion 412 of anchor implant member 104. The threads 126 then rotate in the opposite direction and unscrew or unthread from the receptacle 116 of anchor implant member 104. Once the removable support member 102 has been removed from receptacle 116, an adhesive may be placed within receptacle 116 and then removable support member 102 may then be inserted and rotated as described herein. A desired rotation and location of removable support member 102 is then finalized within anchor implant member 104 prior to adhesive being set in removable support member 102 to anchor implant member 104.

While this invention has been described with reference to illustrative embodiments, this description is not intended to be construed in a limiting sense. Various modifications in combinations of illustrative embodiments as well as other embodiments of the invention will be apparent to persons skilled in the art upon reference to the description. It is, therefore, intended that the appended claims encompass any such modifications or embodiments.

What is claimed:

1. A captive thread dental implant apparatus comprising:
a removable support member having a first receptacle on one end and a first threaded shank portion on the other end, the removable support member having a non-threaded shank portion extending between the first threaded shank portion and the first receptacle; and
an anchor implant member having a lower body portion on one end and a second receptacle on the other end for receiving the first threaded shank portion of the removable support member, the second receptacle having a second threaded portion located within the second receptacle for engaging the first threaded shank portion, the non-threaded shank portion located adjacent to the second threaded shank portion when the removable support member is joined with the anchor implant member.

2. The captive thread dental implant apparatus according to claim 1, wherein the non-threaded shank portion has a diameter that is less than the diameter of second threaded portion.

3. The captive thread dental implant apparatus according to claim 1, wherein the second threaded shank portion is disengaged and in a longitudinally captive thread arrangement from the first threaded shank portion when the removable support member is joined with the anchor implant member.

4. The captive thread dental implant apparatus according to claim 1, wherein the removable support member is freely rotatable relative to the anchor implant member when the removable support member is joined with the anchor implant member.

5. The captive thread dental implant apparatus according to claim 1, wherein the removable support member further comprises:
an abutment portion located between the first receptacle and the first threaded portion and extending laterally from the removable support member for abutting against the second receptacle to provide a stop between removable support member and the second receptacle.

6. The captive thread dental implant apparatus according to claim 5, wherein the abutment portion has a diameter that is one of greater or equal to the outer diameter of the second receptacle.

7. The captive thread dental implant apparatus according to claim 1, wherein the lower body portion further comprises:
a longitudinally extending threaded portion for engaging the bone of a patient for anchoring the anchor implant member to a bone of a patient.

8. A captive thread dental implant apparatus comprising:
a removable support member having a first receptacle on one end and a first threaded shank portion on the other end, the removable support member having a non-threaded shank portion extending between the first threaded shank portion and the first receptacle, wherein the first receptacle provides a female interference fit for releasably engaging a male end of a dental prosthesis; and
an anchor implant member having a lower body portion on one end and a second receptacle on the other end for receiving the first threaded shank portion of the removable support member, the second receptacle having a second threaded portion located within the second receptacle for engaging the first threaded shank portion, the non-threaded shank portion located adjacent to the second threaded shank portion when the removable support member is joined with the anchor implant member.

9. The captive thread dental implant apparatus according to claim 8, wherein the non-threaded shank portion has a diameter that is less than the diameter of second threaded portion.

10. The captive thread dental implant apparatus according to claim 8, wherein the second threaded shank portion is disengaged and in a longitudinally captive thread arrangement from the first threaded shank portion when the removable support member is joined with the anchor implant member.

11. The captive thread dental implant apparatus according to claim 8, wherein the female interference fit comprises:
a divergent-convergent-divergent cross-sectional diameter.

12. The captive thread dental implant apparatus according to claim 8, wherein the removable support member further comprises:
an abutment portion located between the first receptacle and the first threaded portion and extending laterally from the removable support member for abutting against the second receptacle to provide a stop between removable support member and the second receptacle.

13. The captive thread dental implant apparatus according to claim 12, wherein the abutment portion has a diameter that is one of greater or equal to the outer diameter of the second receptacle.

14. The captive thread dental implant apparatus according to claim 8, wherein the lower body portion further comprises:
a longitudinally extending threaded portion for engaging the bone of a patient for anchoring the anchor implant member to a bone of a patient.

15. The captive thread dental implant apparatus according to claim 8, wherein the first receptacle further comprises:
at least one aperture disposed through the first receptacle.

16. The captive thread dental implant apparatus according to claim 8, wherein the removable support member further comprises:
a cavity extending longitudinally from the first threaded shank portion towards the first receptacle.

17. A captive thread dental implant apparatus comprising:
a removable support member having a first receptacle on one end and a first threaded shank portion on the other end, the removable support member having a non-threaded shank portion extending between the first threaded shank portion and the first receptacle, wherein the first receptacle is adapted to releasably engage a male end of a dental prosthesis; and
an anchor implant member having a lower body portion on one end and a second receptacle on the other end for receiving the first threaded shank portion of the removable support member, the second receptacle having a second threaded portion located within the second receptacle for engaging the first threaded shank portion, the non-threaded shank portion located adjacent to the second threaded shank portion when the removable support member is joined with the anchor implant member.

18. The captive thread dental implant apparatus according to claim 17, wherein the non-threaded shank portion has a diameter that is less than the diameter of second threaded portion.

19. The captive thread dental implant apparatus according to claim 17, wherein the lower body portion further comprises:
a longitudinally extending threaded portion for engaging the bone of a patient for anchoring the anchor implant member to the bone of the patient.

20. The captive thread dental implant apparatus according to claim 17, wherein the second threaded shank portion is disengaged and in a longitudinally captive thread arrangement from the first threaded shank portion when the removable support member is joined with the anchor implant member, wherein the removable support member is freely rotatable relative to the anchor implant member when the removable support member is joined with the anchor implant member.
